(19) United States
(12) Patent Application Publication
(10) Pub. No.: US 2010/0330309 A1
(43) Pub. Date: Dec. 30, 2010

(54) Frit or solder glass compound including beads, and assemblies incorporating the same

(75) Inventor: David J. COOPER, Canton, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 12/458,111

(22) Filed: Jun. 30, 2009

(51) Int. Cl. C03C 8/02; B32B 17/00; E06B 3/26; B32B 17/06; C03C 27/04

(52) U.S. Cl. 428/34; 501/14; 428/325; 428/433; 156/107; 156/102

(57) ABSTRACT

Certain example embodiments of this invention relate to frits or solder glass compounds that include beads, and/or assemblies such as, for example, vacuum insulated glass (VIG) units or plasma display panels (PDPs) including the same. In certain example embodiments, the beads may be hollow glass beads of any suitable shape (e.g., substantially spherical, substantially eye shaped, substantially oblong, substantially square shaped, etc.) with or without evacuated cavities. The inclusion of such beads in a frit material may improve the thermal properties of the bulk fired frit in certain example instances. Additionally, the inclusion of such beads in a frit material may take the place of other more expensive materials in the frit, thereby reducing the costs associated with the fabrication of the assemblies.

### FIELD OF THE INVENTION

Certain example embodiments of this invention relate to frits or solder glass compounds for use assemblies. More particularly, certain example embodiments of this invention relate to frits or solder glass compounds that include beads, and/or assemblies such as, for example, vacuum insulated glass (VIG) units or plasma display panels (PDPs) including the same. In certain example embodiments, the beads may be hollow glass beads of any suitable shape (e.g., substantially spherical, substantially eye shaped, substantially oblong, substantially square shaped, etc.) with or without evacuated cavities. The inclusion of such beads in a frit material may improve the thermal properties of the bulk fired frit in certain example instances. Additionally, the inclusion of such beads in a frit material may take the place of other more expensive materials in the frit, thereby reducing the costs associated with the fabrication of the assemblies.

### BACKGROUND AND SUMMARY OF EXAMPLE EMBODIMENTS OF THE INVENTION

Vacuum IG units are known in the art. For example, see U.S. Pat. Nos. 5,664,395, 5,657,607, and 5,902,652, the disclosures of which are all hereby incorporated herein by reference.

FIGS. 1-2 illustrate a conventional vacuum IG unit (vacuum IG unit or VIG unit). Vacuum IG unit 1 includes two spaced apart glass substrates 2 and 3, which enclose an evacuated or low pressure space 6 therebetween. Glass sheets/substrates 2 and 3 are interconnected by peripheral or edge seal of fused solder glass 4 and an array of support pillars or spacers 5.

Pump out tube 8 is hermetically sealed by solder glass 9 to an aperture or hole 10 which passes from an interior surface of glass sheet 2 to the bottom of recess 11 in the exterior face of sheet 2. A vacuum is attached to pump out tube 8 so that the interior cavity between substrates 2 and 3 can be evacuated to create a low pressure area or space 6. After evacuation, tube 8 is melted to seal the vacuum. Recess 11 retains sealed tube 8. Optionally, a chemical getter 12 may be included within recess 13.

Conventional vacuum IG units, with their fused solder glass peripheral seals 4, have been manufactured as follows. Glass frit in a solution (ultimately to form solder glass edge seal 4) is initially deposited around the periphery of substrate 2. The other substrate 3 is brought down over top of substrate 2 so as to sandwich spacers 5 and the glass frit/solution therebetween. The entire assembly including sheets 2, 3, the spacers, and the seal material is then heated to a temperature of approximately 500° C., at which point the glass frit melts, wets the surfaces of the glass sheets 2, 3, and ultimately forms hermetic peripheral or edge seal 4. This approximately 500° C. temperature is maintained for from about one to eight hours. After formation of the peripheral/edge seal 4 and the seal around tube 8, the assembly is cooled to room temperature. It is noted that column 2 of U.S. Pat. No. 5,664,395 states that a conventional vacuum IG processing temperature is approximately 500° C. for one hour. Inventors Lenzen, Turner and Collins of the '395 patent have stated that “the edge seal process is currently quite slow: typically the temperature of the sample is increased at 200° C. per hour, and held for one hour at a constant value ranging from 430° C. and 530° C. depending on the solder glass composition.” After formation of edge seal 4, a vacuum is drawn via the tube to form low pressure space 6. 100061 Unfortunately, the aforesaid high temperatures and long heating times of the entire assembly utilized in the formulation of edge seal 4 are undesirable, especially when it is desired to use a heat strengthened or tempered glass substrate(s) 2, 3 in the vacuum IG unit. As shown in FIGS. 3-4, tempered glass loses temper strength upon exposure to high temperatures as a function of heating time. Moreover, such high processing temperatures may adversely affect certain low-E coating(s) that may be applied to one or both of the glass substrates in certain instances.

FIG. 3 is a graph illustrating how fully thermally tempered plate glass loses original temper upon exposure to different temperatures for different periods of time, where the original center tension stress is 3,200 MU per inch. The x-axis in FIG. 3 is exponentially representative of time in hours (from 1 to 1,000 hours), while the y-axis is indicative of the percentage of original temper strength remaining after heat exposure. FIG. 4 is a graph similar to FIG. 3, except that the x-axis in FIG. 4 extends from zero to one hour exponentially.

Seven different curves are illustrated in FIG. 3, each indicative of a different temperature exposure in degrees Fahrenheit (° F.). The different curves/lines are 400° F. (across the top of the FIG. 3 graph), 500° F., 600° F., 700° F., 800° F., 900° F., and 950° F. (the bottom curve of the FIG. 3 graph). A temperature of 900° F. is equivalent to approximately 482° C., which is within the range utilized for forming the aforesaid conventional solder glass peripheral seal 4 in FIGS. 1-2. Thus, attention is drawn to the 900° F. curve in FIG. 3, labeled by reference number 18. As shown, only 20% of the original temper strength remains after one hour at this temperature (900° F. or 482° C.). Such a significant loss (i.e., 80% loss) of temper strength is of course undesirable.

In FIGS. 3-4, it is noted that much better temper strength remains in a thermally tempered sheet when it is heated to a temperature of 800° F. (about 428° C.) for one hour as opposed to 900° F. for one hour. Such a glass sheet retains about 70% of its original temper strength after one hour at 800° F., which is significantly better than the less than 20% when at 900° F. for the same period of time.

Another advantage associated with not heating up the entire unit for too long is that lower temperature pillar materials may then be used. This may or may not be desirable in some instances.

Even when non-tempered glass substrates are used, the high temperatures applied to the entire VIG assembly may soften the glass or introduce stresses, and partial heating may introduce more stress. These stresses may increase the likelihood of deformation of the glass and/or breakage.

Moreover, the ceramic or solder glass edge seals of conventional VIG units tend to be brittle and prone to cracking and/or breakage, reducing the ability of individual glass panels to move relative to one another. Glass panel movement is known to occur under normal conditions such as, for example, when two hermetically sealed glass components (such as in a VIG unit) are installed as a component of a window, skylight or door, whereby the VIG unit is exposed to direct sunlight and one glass panel has higher thermal absorption than the other panel or there is a great difference between the interior and exterior temperatures.

Although there are some commercially available “lead-free” frits that begin to address environmental and safety concerns, such frit material tends to be much more expensive than conventional leaded frit material. Indeed, the inventor of the instant invention has noted that current “lead-free” frits, on average, are approximately twenty times more expensive that conventional leaded frits.

Thus, it will be appreciated that there is a need in the art for frit or solder glass materials that are less expensive to make and use, and supply the strength required for use in VIG and/or PDP applications.

One aspect of certain example embodiments relates to replacing at least some of the material in “lead-free” frits with material that has reduced, or no, impact on strength. In this regard, certain example embodiments relate to frits or solder glass material that includes beads (e.g., ceramic beads with solid or evacuated cores), which advantageously replace this material (which may include, for example Bismuth). In such embodiments, the beads may also reduce the bulk conductivity (e.g., bulk thermal conductivity) of the frit. The size and shape of the beads may be selected to have an increased “fill,” resulting in more volume and less impact on strength.

Certain example embodiments of this invention relate to a frit slurry paste comprising a frit powder and a plurality of glass or ceramic beads. The frit slurry paste is substantially lead-free and has a viscosity such that the frit slurry paste is extrudable.

Certain example embodiments of this invention relate to an assembly comprising at least one substrate and a frit formed on the at least one substrate. The frit is formed by firing a frit slurry paste applied to the at least one substrate. The frit slurry paste comprises a frit powder, and a plurality of glass or ceramic beads. The frit slurry paste is substantially lead-free and has a viscosity such that the frit slurry paste is extrudable.

In certain example embodiments, each said bead may be a hollow, vacuum-in-cavity, bead. In certain example embodiments, the plurality of glass or ceramic beads may comprise a plurality of first beads and a plurality of second beads, with the first beads being smaller in size, on average, than the second beads, on average.

Certain example embodiments of this invention relate to a method of making a vacuum insulated glass (VIG) unit. A first substrate is provided. A frit slurry paste is applied around edges of the first substrate. A second substrate is provided such that the first and second substrates are substantially parallel and spaced apart from one another and such that the frit slurry paste is provided around edges of the second substrate. The frit slurry paste is fired to create an edge seal. A cavity formed between the first and second substrate is at least partially evacuated. The frit slurry paste has a bulk viscosity of 20,000-100,000 cps and comprises a frit powder, and a plurality of hollow, vacuum-in-cavity beads. The frit slurry paste is substantially lead-free.

In certain example embodiments, the VIG unit may have a reduced thermal conductivity proximate to an edge seal thereof relative to a VIG unit having an edge seal formed from a frit slurry paste that lacks any beads, and the edge seal may have a compressive strength suitable to support the first and second substrates of the VIG unit.

The features, aspects,.advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a prior art cross-sectional view of a conventional vacuum IG unit;

FIG. 2 is a prior art top plan view of the bottom substrate, edge seal, and spacers of the FIG. 1 vacuum IG unit taken along the section line illustrated in FIG. 1;

FIG. 3 is a graph correlating time (hours) versus percent tempering strength remaining, illustrating the loss of original temper strength for a thermally tempered sheet of glass after exposure to different temperatures for different periods of time;

FIG. 4 is a graph correlating time versus percent tempering strength remaining similar to that of FIG. 3, except that a smaller time period is provided on the x-axis;

FIG. 5 is a cross-sectional view of a portion of an example assembly according to certain example embodiments; and

FIG. 6 is a cross-sectional view of a portion of another example assembly according to certain example embodiments.

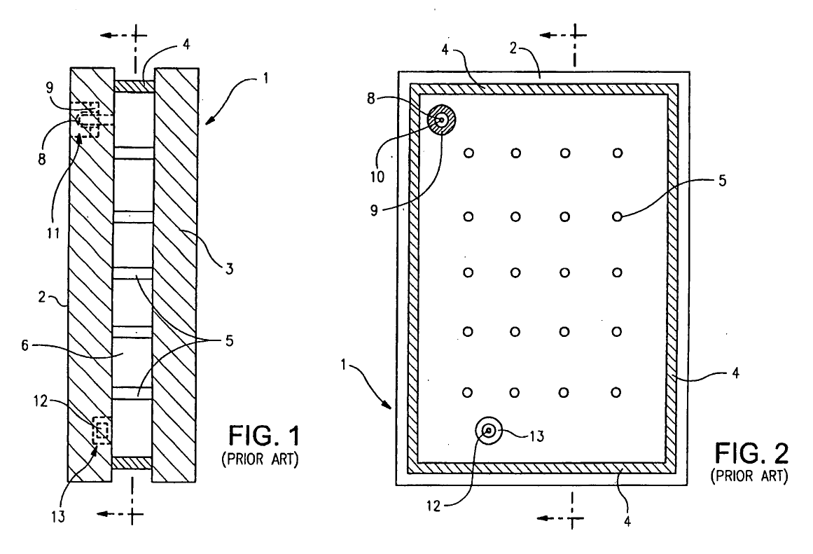

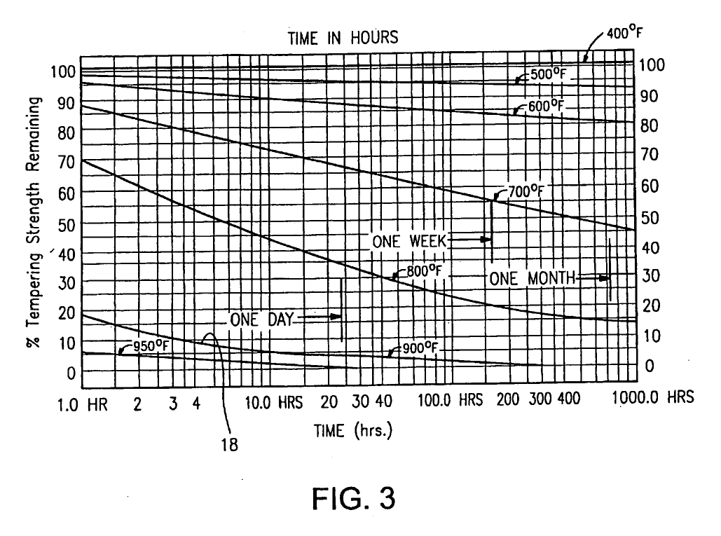

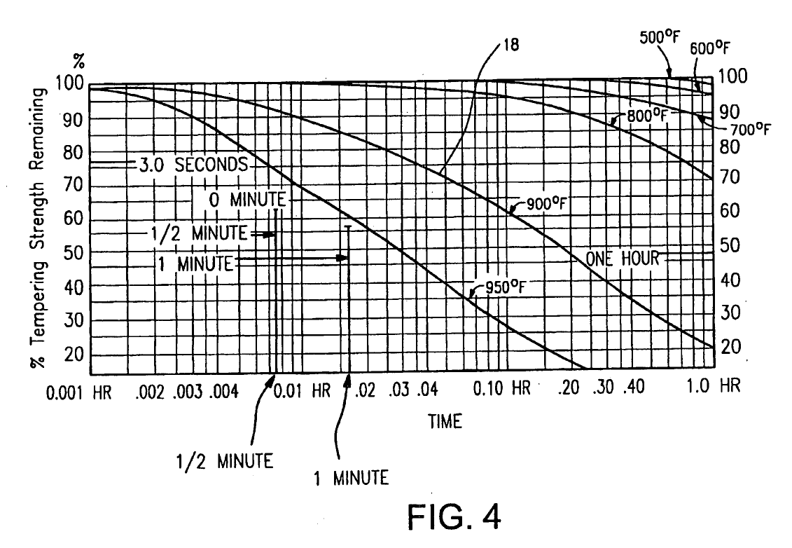

### DETAILED DESCRIPTION OF EXAMPLE EMBODIMENTS OF THE INVENTION

Certain example embodiments of this invention relate to frits or solder glass compounds that include beads, and/or assemblies such as, for example, vacuum insulated glass (VIG) units or plasma display panels (PDPs) including the same. In certain example embodiments, the beads may be hollow glass beads of any suitable shape (e.g., substantially spherical, substantially eye shaped, substantially oblong, substantially square shaped, etc.) with or without evacuated cavities. In certain example embodiments, hollow or solid beads may be added to a wet frit slurry, ink, or paint for use in plasma display panels (PDPs), vacuum insulated glass (VIG) units, or other assemblies. In certain example embodiments, the beads may be hollow glass beads of any suitable shape (e.g., substantially spherical, substantially eye shaped, substantially oblong, substantially square shaped, etc.) with hollow (and sometimes evacuated) or solid cavities. The wet frit slurry, ink, or paint with the beads of certain example embodiments may be used as a mask on the glass surface, to help bond two substrates together (e.g., glass to glass, metal to metal, glass to metal, etc.), as edge seals, etc. The inclusion of the beads in certain example applications improves processing characteristics such as flowability of the material and also reduces the thermal conductivity properties of solidified frit, paint, or ink. Furthermore, the inclusion of such beads in a frit material may take the place of other more expensive materials in the frit, thereby reducing the costs associated with the fabrication of the assemblies in certain example instances.

Beads suitable for use in certain example embodiments may be obtained from a commercial vendor. For example, 3M provides a line of hollow glass microspheres under the tradename “Glass Bubbles.” The hollow glass microspheres have a high strength-to-density ratio, thereby making them lightweight and robust. In general, the beads of certain example embodiments may have a density of 0.1 to 1.0 g/cc, preferably greater than 0.2 g/cc, and an isostatic crush strength of 50-50,000 psi, preferably greater than about 500 psi. Commercially available 3M products that fall within this range include, for example, Glass Bubbles A16/500, A20/1000, D32/4500, H20/1000, H50/10000 EPX, K1, K11, K15, K20, K25, K37, K46, S15, S22, S32, S35, S38, S38HS, S38XHS, S60, and S60HS. In certain example embodiments, the beads may be surface treated or coated with coupling agents, viscosity altering agents such as surfactants, appearance altering agents such as dyes, pigments, and the like, etc. Of course, it will be appreciated that this may not be desirable for VIG unit applications, as organics on the surface tend to create a problem with organic outgassing.

In certain example embodiments, beads are selected for inclusion into the slurry in a ratio of 2.5-90%, more preferably 5-75%, still more preferably 5-60%. Different sizes and/or volumes may be employed in certain example embodiments, for example, to adjust and improve slurry flow characteristics and rheology, or final product physical, thermal, conductive, and/or other properties. In certain example embodiments, beads of different sizes and/or volumes may be incorporated into the same slurry. The incorporation of different sizes and/or volumes may be advantageous in certain example instances, e.g., to provide more volume or additional “fill,” thereby helping the fired frit retain a high strength. In certain example embodiments, a mixture of more than two different sizes may be provided. In certain example embodiments, a mixture of random sizes having a predetermined percentage by volume at a given area size may be provided, e.g., as a mesh screen.

It will be appreciated that the beads of certain example embodiments will not be used to determine the fired frit height once mixture is melted. Instead, the beads of certain example may be used as filler material to obtain better thermal transfer or lower conductivity, e.g., as described in greater detail below. Additionally, the beads of certain example embodiments may be used to reduce the need for toxic, harmful, or disadvantageous frit material (e.g., lead), and/or to reduce the need for expensive frit material (e.g., Bismuth-based material), etc. For example, the beads of certain example embodiments may take the place of at least some of the bismuth-based material that is found in some lead-free frits. Thus, a frit or solder glass material of certain example embodiments may include a Bismuth-based material such as, for example, Bi₂O₃—B₂O₃, along with a plurality of similar or differently sized beads.

The beads are added to the mixture and dispersed throughout. Conventional mixing equipment that does not break or crush the beads may be used in this regard, e.g., to substantially uniformly distribute the beads in the mixture. The slurry mixture may be pumped or extruded using various techniques that do not crush the beads. For example, diaphragm, peristaltic, and/or other pump types may be used in this connection. The resultant rheology of the designed recipe may improve flow characteristics of the bulk slurry properties. It will be appreciated that the size, shape, and amount of beads in certain example embodiments may be used to achieve a viscosity similar to or the same as a conventional frit slurry paste. However, this generally will not be a concern, given the small size and low surface area of the beads. Although the viscosity range may vary for various frit slurry pastes produced in accordance with different example embodiments, a viscosity range of 2,000-500,000 cps generally is preferable, a viscosity range of 20,000-250,000 cps or 20,000-200,000 being more preferable. Sometimes, the viscosity range may reach 40,000-80,000 cps, which is close to the viscosity range of conventional frit slurry pastes.

The slurry as applied is dried, e.g., with a heat, via a vacuum, or a combination of the two. The slurry is in contact with the two substrates to be joined and fired at the appropriate temperature such that the beads do not reach the softening point. For example, where the beads are glass spheres, the heat will be lower than Tg. The resultant fired frit or solder glass will have a combination of bulk properties of the frit and the spheres. One example benefit in using evacuated hollow beads is cost savings, especially where more expensive frits are used. Another example benefit is a reduction in the thermal conductivity relative to the amount of bead additive, e.g., proximate to the frit.

When included in assemblies such as VIG units or PDPs, the frit or solder glass compounds having beads may result in thermal conductivity improvements in certain example instances. That is, where a decrease in conductivity is desirable (e.g., for a VIG unit), the addition of hollow compounds will reduce the thermal conductivity through the frit or solder glass. This resistance to thermal transfer will, in turn, improve the overall U-value of the unit. As is known, the U-value (or U-factor) generally relates to the overall heat transfer coefficient and describes how well a building element conducts heat by measuring the rate of heat transfer through, for example, a building element over a given area, under standardized conditions. The usual standard is at a temperature gradient of 24 degrees C., at 50% humidity with no wind, and smaller U-values typically are considered more desirable than larger U-values. As an example, when the thermal conductivity decrease is desirable such as in a VIG unit, assuming 60% by volume evacuated hollow glass spheres in the bulk slurry mixture, with calculated thermal conductivity of k=0.085 W/mK, the calculated bulk thermal conductivity of the fired frit will be improved by about 55%. Thus, it will be appreciated that the decrease in thermal conductivity at the perimeter frit (or edge seal) will improve the overall performance for an installed VIG unit in a window or door product. In general a thermal conductivity decrease of about 5% is desirable for certain example VIG unit application although, as shown above, it is possible to decrease conductivity by 55% and sometimes even more.

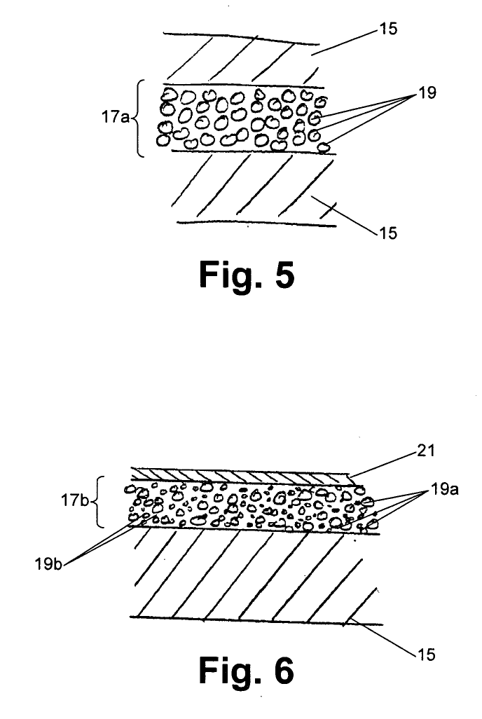

FIG. 5 is a cross-sectional view of a portion of an example assembly according to certain example embodiments. FIG. 5 shows first and second glass substrates 15, e.g., of the type that may be found in a VIG unit. The first and second substrates 15 sandwich a frit 17a that includes a plurality of beads 19 along with a frit material, which frit material may be “lead-free.” The beads 19 in the frit 17a of FIG. 5 are shown as being substantially uniform in size and shape. It will be appreciated that the assembly bulk frit 17a will have a decreased conductivity as compared to embodiments where the frit does not include any beads 19.

FIG. 6 is a cross-sectional view of a portion of another example assembly according to certain example embodiments. The FIG. 6 example embodiment shows a glass substrate 15 and a metal substrate 21. Such an arrangement may be used, for example, in a PDP assembly, e.g., to mask the metal substrate 21 proximate to the edges of the panel. Similar to the FIG. 5 embodiment, the glass substrate 15 and the metal substrate 21 in the FIG. 6 embodiment sandwich a frit 17b that includes a plurality of beads 19a and 19b along with a frit material. Again, this frit material may be “lead-free.” Unlike the FIG. 5 example embodiment, however, the FIG. 6 example embodiment includes differently sized and/or shaped beads. That is, the FIG. 6 example embodiment includes larger beads 19a and smaller beads 19b. The inclusion of differently sized and/or shaped beads in this and/or similar manners may provide for increased strength in the fired frit, as the fill volume is increased because of the differently sized beads.

Although FIGS. 5 and 6 have been described as relating to glass and metal substrates, it will be appreciated that any suitable substrates may be used in connection with different embodiments of this invention. The beads shown in FIGS. 5 and 6 are shown as being hollow and may be vacuum cavity beads in certain example embodiments. In certain other example embodiments, the beads may be solid.

In certain example embodiments, the frit material may be only about 2-20 mm thick, although this thickness may vary within or outside of this range depending on the example application. The beads of certain example embodiments may range from 20-200 microns, e.g., in diameter or width. An example embodiment may be said to have a substantially uniform bead size even though the bead sizes may not always be exactly the same, e.g., as a result of manufacturing processes that lead to non-uniformity. In certain example instances, bead size may be said to be substantially uniform in size if most of the beads are within 1-3 standard deviations of one another.

It will be appreciated that the frit material having beads may be used for pillars in certain example instances, e.g., when the pillars have a sufficient mechanical compressive strength. For example, material may be extruded, e.g., in a long flow, and then cut into pillars as the material is being extruded. As another example, pre-formed pillars may be formed, applied to the glass, and then fired. The pillars may be optimized for desired color characteristics. Although the appearance of the pillars may not be important in tinted or low visible transmission glass, for example, other embodiments may involve “clear” frit material and “clear” bubbles. In general, for VIG unit applications in accordance with certain example embodiments, a frit material may be applied to a substrate and melted, and then the cavity between the substrates may be evacuated.

In certain example embodiments, the height of the frit or the thickness between substrates may be substantially equal to the height of the pillar. For instance, the frit height or thickness preferably varies by no more than ±15%, more preferably ±10%, still more preferably ±5%. It will be appreciated that this increased uniformity is a marked improvement over conventional methods of flowing the solder glass in which, following firing, creates a bend in the glass at the edge that imparts static stresses.

In certain example embodiments, the frit slurry paste comprising the beads may be extruded in a predetermined shape. Once extruded, the frit slurry paste may be fired or otherwise heated to form a rigid component that is applied to edges of the first and/or second substrates. The rigid component may be re-fired or otherwise re-heated in making the VIG unit.

It will be appreciated that a frit may include some amount of lead and still be considered “lead free.” For example, a frit may include several PPM lead and still be said to be “lead free.” In general, a “lead-free” frit will be any frit that has an amount of lead below a toxic threshold.

“Peripheral” and “edge” seals herein do not mean that the seals are located at the absolute periphery or edge of the unit, but instead mean that the seal is at least partially located at or near (e.g., within about two inches) an edge of at least one substrate of the unit. Likewise, “edge” as used herein is not limited to the absolute edge of a glass substrate but also may include an area at or near (e.g., within about two inches) of an absolute edge of the substrate(s). Also, it will be appreciated that as used herein the term “VIG assembly” refers to an intermediate product prior to the VIG's edges being sealed and evacuation of the recess including, for example, two parallel-spaced apart substrates. Also, while a component may be said to be “on” or “supported” by one or more of the substrates herein, this does not mean that the component must directly contact the substrate(s). In other words, the word “on” covers both directly and indirectly on, so that the component may be considered “on” a substrate even if other material (e.g., a coating and/or thin film) is provided between the substrate and the component.

It will be appreciated that the example embodiments described herein may be used in connection with a variety of different VIG assembly and/or other units or components. For example, the substrates may be glass substrates, heat strengthened substrates, tempered substrates, etc.

The terms “heat treatment” and “heat treating” as used herein mean heating the article to a temperature sufficient to enabling thermal tempering, bending, and/or heat strengthening of the glass. This includes, for example, heating an article to a temperature of at least about 580 or 600 degrees C. for a sufficient period to enable tempering and/or heat strengthening, more preferably at least about 600 degrees C., and sometimes to 625 degrees C. In some instances, the HT may be for at least about 4 or 5 minutes.

It is noted that the glass substrate(s) may be heat treated in certain example embodiments so that the glass substrate(s) is/are either heat strengthened or thermally tempered (e.g., at a temperature of at least about 580 degrees C., more preferably at least about 600 degrees C., and often at least about 620 or 640 degrees C.).

Certain example embodiments may provide localized heating to and/or IR heating of the frits as disclosed in, for example, application Ser. Nos. 12/000,663 and 12/000,791, the entire contents of each which are hereby incorporated herein by reference. This may be facilitated by designing the frit of certain example embodiments to absorb infrared, e.g., in the 800-2000 nm regions (or any sub-regions therein). This may be accomplished, for example, by providing additives that will absorb these wavelengths. These additives may be provided at various times including, for example, during the batch recipe of the frit and melted into the glass frit, added as powder to the base powdered frit, etc. In such cases, the frit preferably will heat up and melt while having only a small, if any, impact on the beads included in the mixture.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A frit slurry paste, comprising:
a frit powder; and
a plurality of glass or ceramic beads,
wherein the frit slurry paste is substantially lead-free and has a viscosity such that the frit slurry paste is extrudable.

2. The frit slurry paste of claim 1, wherein each said bead is hollow.

3. The frit slurry paste of claim 2, wherein each said bead has an evacuated cavity.

4. The frit slurry paste of claim 1, wherein the beads in the plurality of glass or ceramic beads are substantially uniformly sized.

5. The frit slurry paste of claim 1, wherein the beads in the plurality of glass or ceramic beads, on average, are differently sized.

6. The frit slurry paste of claim 1, wherein each said bead is substantially spherical.

7. The frit slurry paste of claim 1, wherein each said bead is substantially eye-shaped.

8. The frit slurry paste of claim 1, wherein the frit powder is Bismuth-based.

9. An assembly, comprising:
at least one substrate; and
a frit formed on the at least one substrate, the frit being formed by firing a frit slurry paste applied to the at least one substrate, the frit slurry paste comprising:
a frit powder, and
a plurality of glass or ceramic beads,
wherein the frit slurry paste is substantially lead-free and has a viscosity such that the frit slurry paste is extrudable.

10. The assembly of claim 9, wherein each said bead is hollow, vacuum-in-cavity, bead.

11. The assembly of claim 10, wherein the beads are substantially uniformly sized.

12. The assembly of claim 10, wherein the plurality of glass or ceramic beads comprises a plurality of first beads and a plurality of second beads, the first beads being smaller in size, on average, than the second beads, on average.

13. The assembly of claim 10, wherein each said bead is substantially spherical.

14. The assembly of claim 9, further comprising first and second substrates,
wherein the frit is provided as an edge seal between the first and second substrates.

15. The assembly of claim 14, wherein the assembly is a vacuum insulating glass (VIG) unit.

16. The assembly of claim 9, wherein the frit is sandwiched between the at least one substrate and a metal layer.

17. The assembly of claim 16, wherein the assembly a plasma display panel (PDP).

18. A method of making a vacuum insulated glass (VIG) unit, the method comprising:
providing a first substrate;
applying a frit slurry paste around edges of the first substrate;
providing a second substrate such that the first and second substrates are substantially parallel and spaced apart from one another and such that the frit slurry paste is provided around edges of the second substrate;
firing the frit slurry paste to create an edge seal; and
at least partially evacuating a cavity formed between the first and second substrate,
wherein the frit slurry paste has a bulk viscosity of 20,000-100,000 cps and comprises:
a frit powder, and
a plurality of hollow, vacuum-in-cavity beads, and
wherein the frit slurry paste is substantially lead-free.

19. The method of claim 18, wherein the plurality of beads comprises a plurality of first beads and a plurality of second beads, the first beads being smaller in size, on average, than the second beads, on average.

20. The method of claim 19, wherein the VIG unit has a reduced thermal conductivity proximate to an edge seal thereof relative to a VIG unit having an edge seal formed from a frit slurry paste that lacks any beads, and wherein the edge seal has a compressive strength suitable to support the first and second substrates of the VIG unit.

21. The method of claim 18, further comprising:
extruding the frit slurry paste comprising the beads in a predetermined shape;
firing or heating the extruded frit slurry paste to form a rigid component that is applied to edges of the first and/or second substrates; and
firing or heating the rigid component in making the VIG unit.
